(19) United States
(12) Patent Application Publication
(10) Pub. No.: US 2014/0149568 A1
(43) Pub. Date: May 29, 2014

(54) MONITORING ALERTS IN A COMPUTER LANDSCAPE ENVIRONMENT

(71) Applicant: SAP AG, Walldorf (DE)

(72) Inventors: Wulf Kruempelmann, Altlussheim (DE); Clemens Jacob, Mannheim (DE)

(73) Assignee: SAP AG, Walldorf (DE)

(21) Appl. No.: 13/685,377

(22) Filed: Nov. 26, 2012

(51) Int. Cl. H04L 12/26

(52) U.S. Cl. CPC H04L 12/2618
USPC 709/224

(57) ABSTRACT

In a landscape environment, embodiments disclosed herein aggregate alerts into a root alert to reduce the overall alerts being analyzed. A dependency matrix can be used to determine alerts that are redundant due to being derived from a same root problem. In some embodiments, a first alert of a potential problem can be received from a first application or first resource. As a result, a dependency matrix can be checked to determine if a related alert has occurred that is associated with the first alert. If a related alert has already occurred, the first alert can be suppressed. Otherwise, the first alert can be transmitted for further evaluation, such as to a help desk. By suppressing alerts that are dependent on other alerts, a root alert can be generated and forwarded for further evaluation.

### BACKGROUND

A landscape environment can include a hierarchy of computers spanning different countries. The hierarchy can include multiple server computers acting as a single logical entity and providing a single logical service. Additionally, the landscape may be a cluster of interdependent software servers, where at least one server is dependent on another server in the landscape so that the servers can be functionally dependent on each other to work together. One example of a landscape is a database server, a J2EE server, and a web server. Other examples include an Enterprise Resource Planning (“ERP”) server, a Customer Relationship Management (“CRM”) server, and a Web Portal server, where the Web Portal allows users to access the other servers over the Web.

The landscape hierarchy can execute common business processes that communicate with data centers in different countries. At the top of the hierarchy can be a landscape controller that monitors alerts from the data centers to detect hardware or software problems that can occur across the system.

The alerts are a central element of monitoring in a computer landscape. They quickly and reliably report errors or warnings—such as values exceeding or falling below a particular threshold value or that an IT component has been inactive for a defined period of time. However, exorbitant numbers of alerts or events and the very high complexity of solutions can make monitoring alerts difficult.

### SUMMARY

In a landscape environment, embodiments disclosed herein aggregate alerts into a root alert to reduce the overall alerts being analyzed. A dependency matrix can be used to determine alerts that are redundant due to being derived from a same root problem.

In one embodiment, a first alert of a potential problem can be received from a first application or first resource. As a result, a dependency matrix can be checked to determine if a related alert has occurred that is associated with the first alert. If a related alert has already occurred, the first alert can be suppressed. Otherwise, the first alert can be transmitted for further evaluation, such as to a help desk. By suppressing alerts that are dependent on other alerts, a root alert can be generated and forwarded for further evaluation.

This Summary is provided to introduce a selection of concepts, in a simplified form, that are further described hereafter in the Detailed Description. This Summary is not intended to identify key features or essential features of the claimed subject matter nor is it intended to be used to limit the scope of the claimed subject matter.

### BRIEF DESCRIPTION OF THE DRAWINGS

FIG. 1 is a flowchart of a method for monitoring alerts using a dependency matrix.

FIG. 2 is a system diagram of a landscape environment with a hierarchy of agents and a hierarchical dependency matrix can be used to monitor alerts.

FIG. 3 is a diagram illustrating a hierarchy of agents used to monitor alerts.

FIG. 4 is a diagram illustrating updating the hierarchical dependency matrix.

FIG. 5 is a diagram illustrating an alert aggregator that intelligently combines alerts in the landscape environment.

FIG. 6 shows an exemplary embodiment of the alert aggregator and dependency matrix.

FIG. 7 is a flowchart of an embodiment for determining if multiple alerts are related to a root problem.

FIG. 8 shows another example of a dependency matrix.

### DETAILED DESCRIPTION

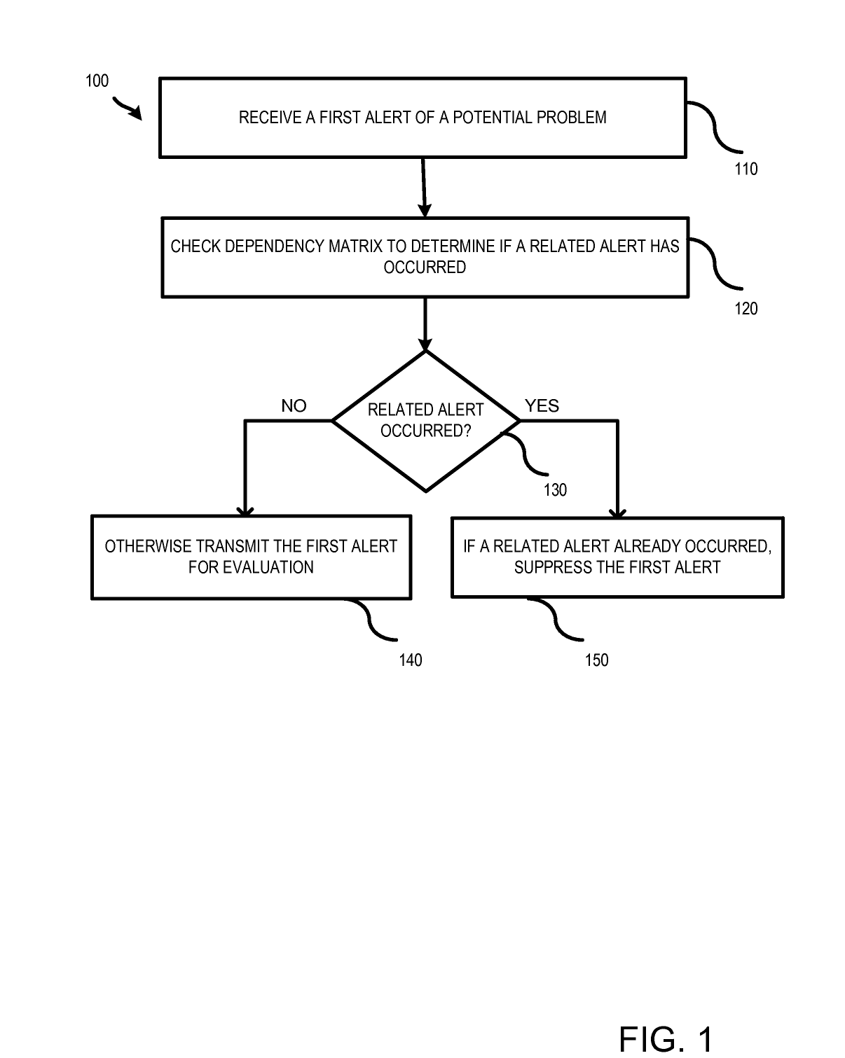

FIG. 1 is a flowchart for monitoring alerts in a landscape environment. In process block 110, a first alert is received for a potential problem. The first alert can be one of multiple alerts that occur in the landscape environment. The alert can be a warning of a potential problem or an actual error. For example, a warning can be issued if a hard drive exceeds a threshold amount of available storage and an actual error can be issued if the hard drive fails. Any desired alerts can be used based on the particular design. The first alert can be received by one of a plurality of agents in the landscape environment or by an alert aggregator, as further described below. In process block 120, a dependency matrix can be checked to determine if an alert has already occurred that is related. For example, if the first alert is from a software application attempting to access a hard drive, and a hard drive failure alert has already been received, then the dependency matrix can indicate that a related alert has already occurred. In decision block 130, a check can be made to determine if a related alert occurred using the data in the dependency matrix. If decision block 130 is answered in the negative, then in process block 140, the first alert can be transmitted for further evaluation. Transmitting the first alert can be to a higher level in a hierarchy of the landscape environment, or can be to a help desk. In any event, transmitting the first alert can result in corrective action being taken. If decision block 130 is answered in the affirmative, then in process block 150, the first alert can be suppressed. Suppressing the first alert can be desirable because the related alert was already transmitted for further evaluation. In one example, a help desk can receive a single root alert rather than receiving multiple alerts relating to the same event. For example, in the case where there is a hardware failure of a disk drive, an alert can be issued that is transmitted for evaluation by a help desk. However, subsequent alerts from applications or databases that attempt to access the hard drive can be suppressed.

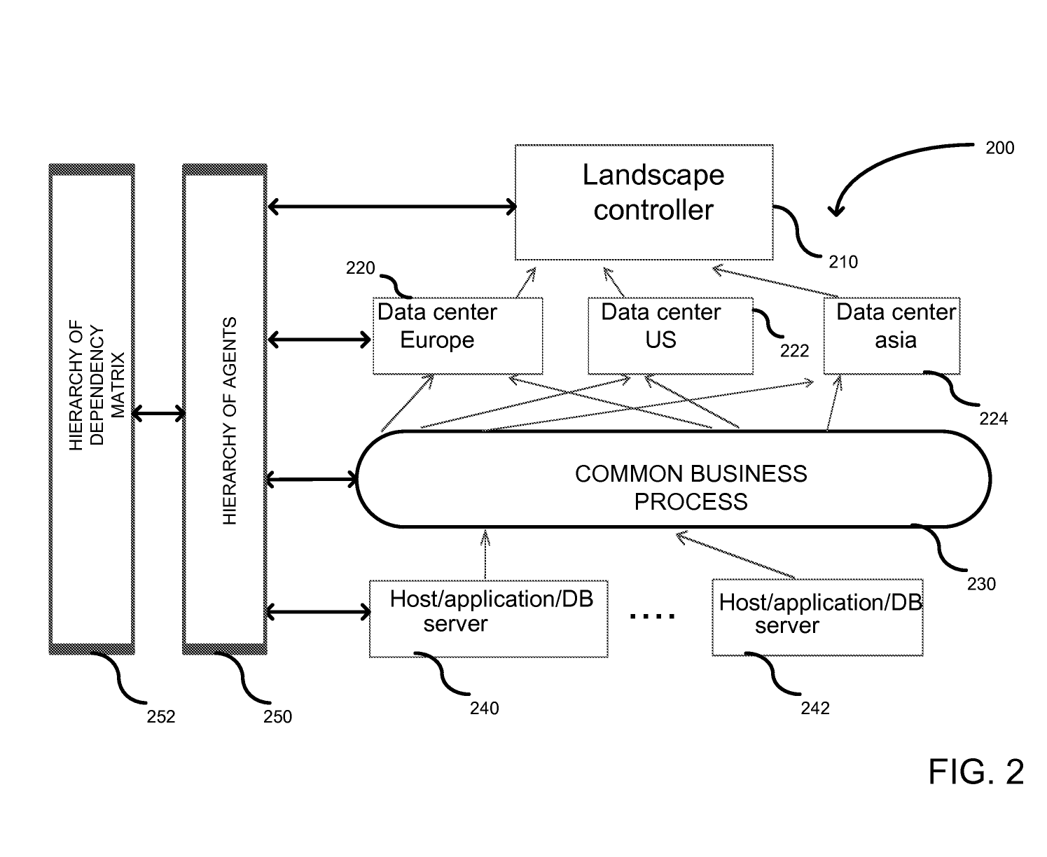

FIG. 2 is an example of a landscape environment 200. At a top of a hierarchy of components in the landscape environment 200, is a landscape controller 210. The landscape controller 210 can receive communications from multiple data centers 220, 222, 224. The data centers can be located in different regions or countries. For example, data center 220 is indicated as being located in Europe, while data center 222 is located in the United States, and data center 224 is located in Asia. Any number of data centers can be used, although only three are shown for simplicity. The data centers can receive communications from a common business process 230, such as an application that is executing across multiple server computers 240, 242. The servers 240, 242 can act as hosts, run applications, or function as data base servers. However, they are used, the servers 240, 242 can cooperate together to provide the common business process 230. A hierarchy of agents 250 can monitor the different components in the landscape environment 200. For example, alerts can be received by the hierarchy of agents 250 from the servers 240, 242, the common business process 230, and the data centers 220, 222, 224. The hierarchy of agents 250 can access a hierarchical dependency matrix 252. The dependency matrix 252 can store recent alerts so that the hierarchy of agents 250 can determine whether to pass alerts to a higher level in the hierarchy, to suppress the alerts, or to provide an auto response for the alerts. Ultimately, the final result of the alerts can be passed to the landscape controller. Each level of the dependency matrix can have dependencies supplied by its respective agents. As is well understood in the art, the dependency matrix 252 can be stored in one file or can be separate files. Additionally, the structure of the dependency matrix 252 can vary depending on the system. For example, if there are several blocks of items, which only depend between each other (no external dependencies), then a separate dependency matrix can be built for these blocks. Nonetheless, such a separate dependency matrix can be viewed as a part of a larger dependency matrix.

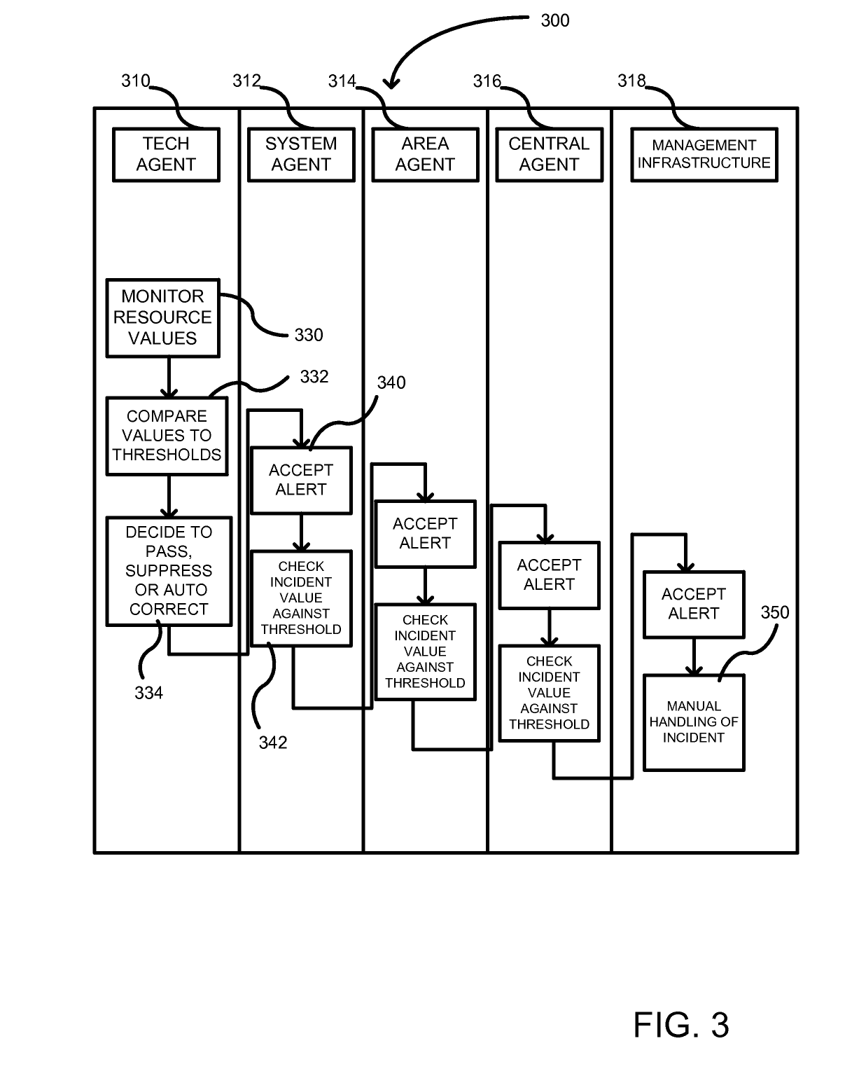

FIG. 3 illustrates a hierarchy of agents 300. The illustrated lowest level of the hierarchy is a technical agent 310. The technical agent can monitor low-level resources, such as hardware devices and applications. A system agent 312 can monitor multiple of the technical agents and other system-level alerts. The area agent 314 can monitor multiple systems, while the central agent 316 can monitor alerts from multiple area agents. Finally, the management infrastructrure 318 can receive alerts from all of the different agents and make intelligent decisions about how to respond to such alerts.

As illustrated in FIG. 3, each agent can have a process for handling alerts and can decide to pass alerts up to a higher level in the hierarchy. For example, the technical agent 310 can monitor resource values (e.g., capacity levels, temperature, voltage, etc.) at 330. At 332, the technical agent can compare the resource values to predetermined thresholds at 332. At 334, based on the comparison, the technical agent 310 can decide to pass the alert onto a higher level in the hierarchy, perform an auto correction, or suppress the alert. The decision can be based in part on information in a dependency matrix associated with the technical agent. When a system agent 312 receives an alert from the technical agent 310, it can accept the alert at 340. The system agent can check the value against a threshold value at 342, and either forward the alert, suppress it, or send an auto correction. The other agents 314, 316 can have similar options. At the management infrastructure level 318, at process block 350, a manual handling of incident can be requested so that a physical person can respond to the alert.

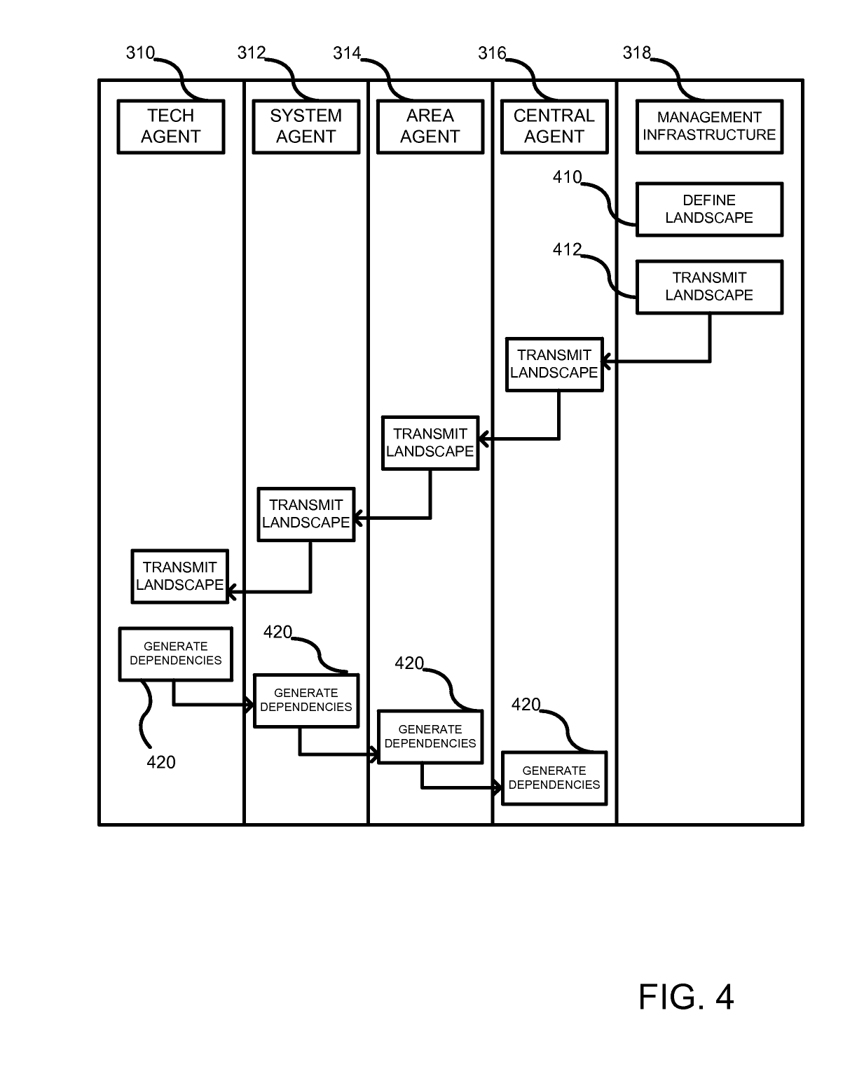

FIG. 4 illustrates how the dependency matrix can be formulated using the hierarchical structure of the agents 300. At 410, the landscape structure can be defined. For example, user input can be received describing a structure of the landscape and such a structure can be saved at the management infrastructure level 318. At 412, the landscape can be transmitted down through the agent levels. Using the landscape definition, each agent 310, 312, 314, 316, can generate dependencies associated with its respective level, as shown generically at 420. Together, the generated dependencies can create the hierarchy 252 (FIG. 2) of the dependency matrix.

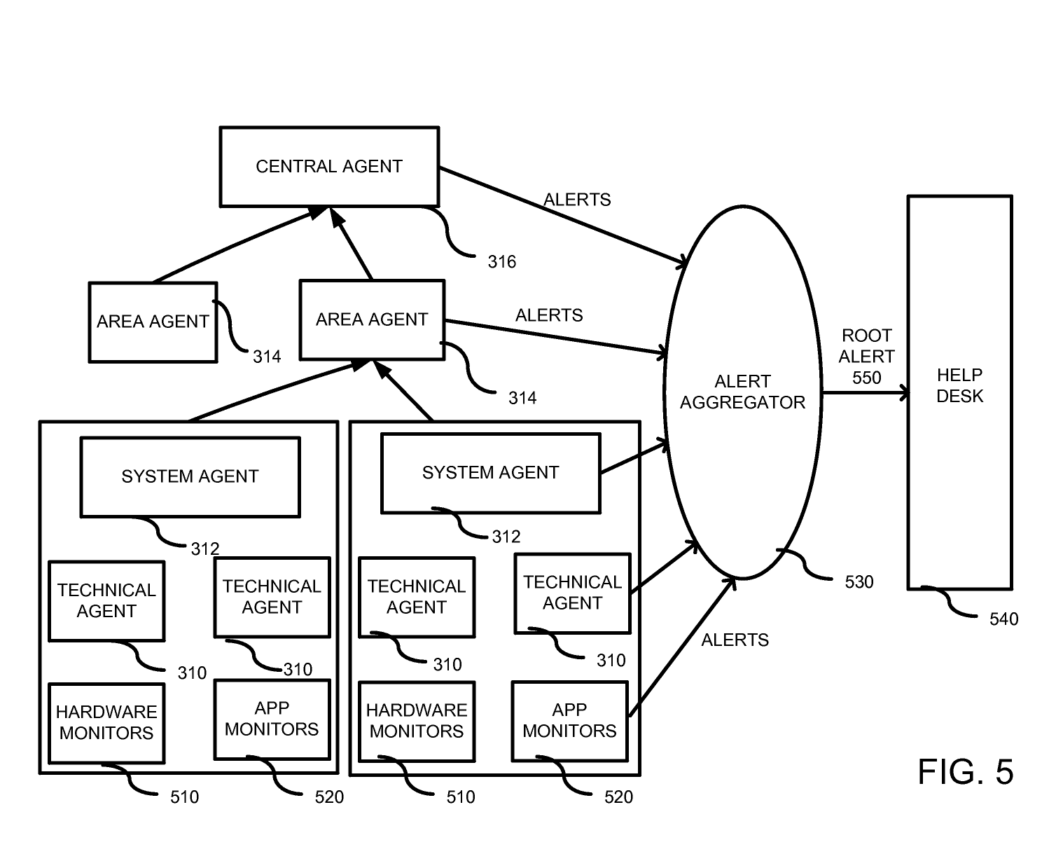

FIG. 5 shows another system embodiment that can be used. In this embodiment, the central agent 316, area agents 314, system agents 312, and technical agents 310 are shown in a landscape hierarchical environment. At the lowest level, alerts can be generated by hardware monitors 510 and application monitors 520. Such alerts can be passed directly to an alert aggregator 530, or to an agent at a higher level of the hierarchy. Multiple alerts can be passed in parallel to the alert aggregator 530. The alert aggregator can access a dependency matrix in order to reduce a number of alerts sent to a help desk 540. The combined alerts can be called a root alert 550. One technique for combining alerts is to suppress some alerts, while allowing the most interesting alert to pass. The alert aggregator can also send auto responses if it is indicated in the dependency matrix that an auto response can be transmitted. Thus, the root alert can describe the genesis or origin of the problem. Other related alerts can be generated after the root alert occurs. For example, a hardware failure can be detected as a root alert. Subsequent software errors can later be detected when the software attempts to access the hardware. The software errors can be suppressed if the hardware error was already reported. If a particular alert can have multiple possible root causes, the alert can be passed onto a higher level to be handled, such as allowing an operator to handle the alert manually.

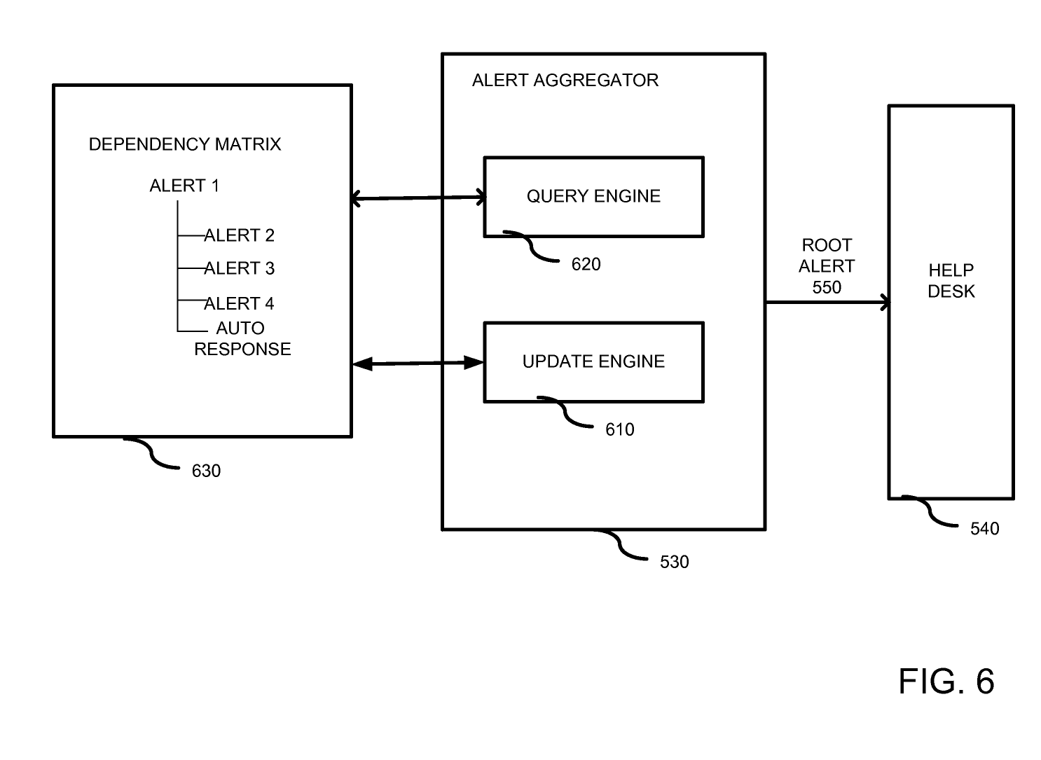

FIG. 6 shows an exemplary alert aggregator 530. In this embodiment, the alert aggregator can include an update engine 610 and a query engine 620. The update engine 610 can be used to updating a dependency matrix 630 based on customer input of a rule set associated with the alerts. The query engine 620 can access the dependency matrix 630 and use a received alert as a key to search for and determine dependencies associated with the alert. For example, the dependency matrix is shown with an Alert 1 and its associated dependencies, including a list of alerts: Alert 2, Alert 3 and Alert 4. An auto response indication can be used to indicate that an auto response can be used for alert 1 in certain situations. Thus, using the dependency matrix, if alert 2, 3, or 4 has already occurred, then the received alert 1 can be suppressed. Although not shown, the alerts can be time stamped, such that if alert 2 was received within a threshold period of time (a predetermined time range), then alert 1 can be suppressed, otherwise, alert 1 can be passed to the help desk 540. The structure of the dependency matrix can vary based on the particular implementation, but the dependency matrix can contain information about the alert itself, the agent that reported the alert and timing information associated with the alert. If an auto response occurs, it is meant that the alert is not passed to a higher level in the hierarchy. Instead, an automated response to the alert can be sent to the sending agent. The sending agent can then take action to correct the error. In a simple example, if a database alert occurs that indicates that the table space is getting full, the auto response can be used directing someone to link more hard disks to the system to extend the table space. Thus, using the dependency matrix, alerts can have auto replies or be suppressed if they are related to alerts that were already reported. As a result, the overall number of alerts can be reduced being passed to the landscape controller can be reduced.

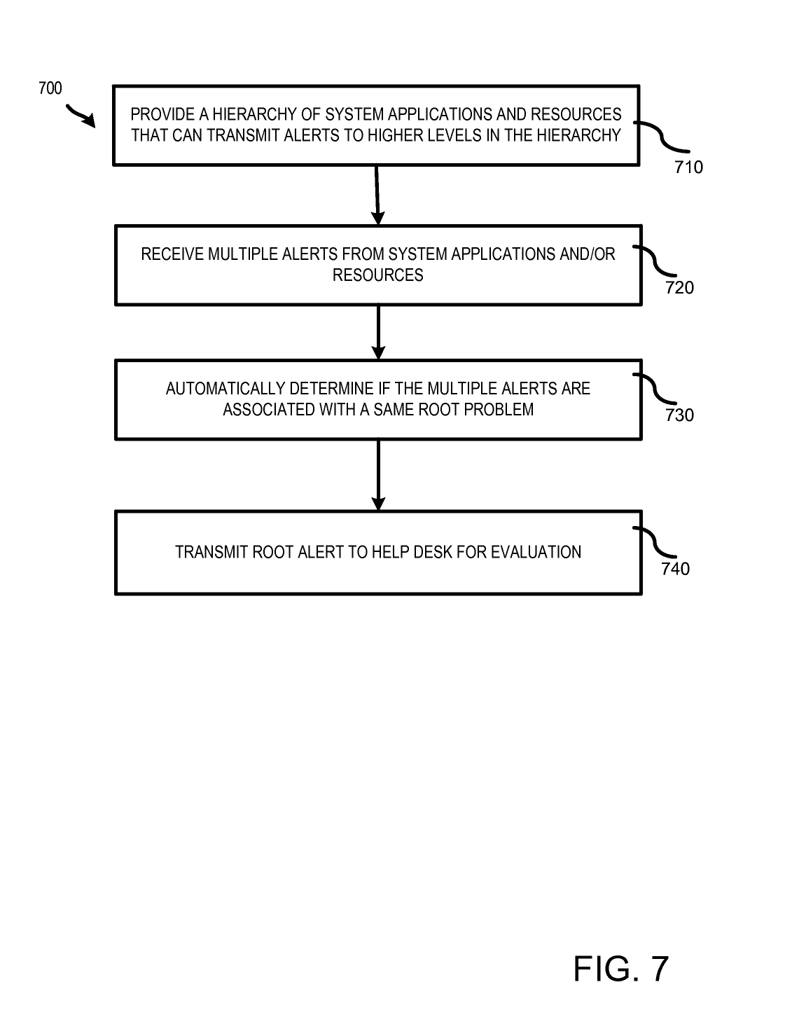

FIG. 7 shows a flowchart of an embodiment that can be used to transmit alerts to a helpdesk. In process block 710, a hierarchy of system applications and resources can transmit alerts to higher levels in the hierarchy. In process 720, multiple alerts can be received from the system applications or resources, such as in an alert aggregator. In process block 730, the alert aggregator can automatically determine if the multiple alerts are associated with the same root problem. For example, the dependency matrix can be used to determine the dependencies between the alerts. Additionally, time stamps can be used to determine how recently the dependent alerts occurred. In process block 740, a root alert can be transferred to a help desk for evaluation based on the dependency between the alerts. Thus, the total number of alerts transmitted to the help desk can be reduced.

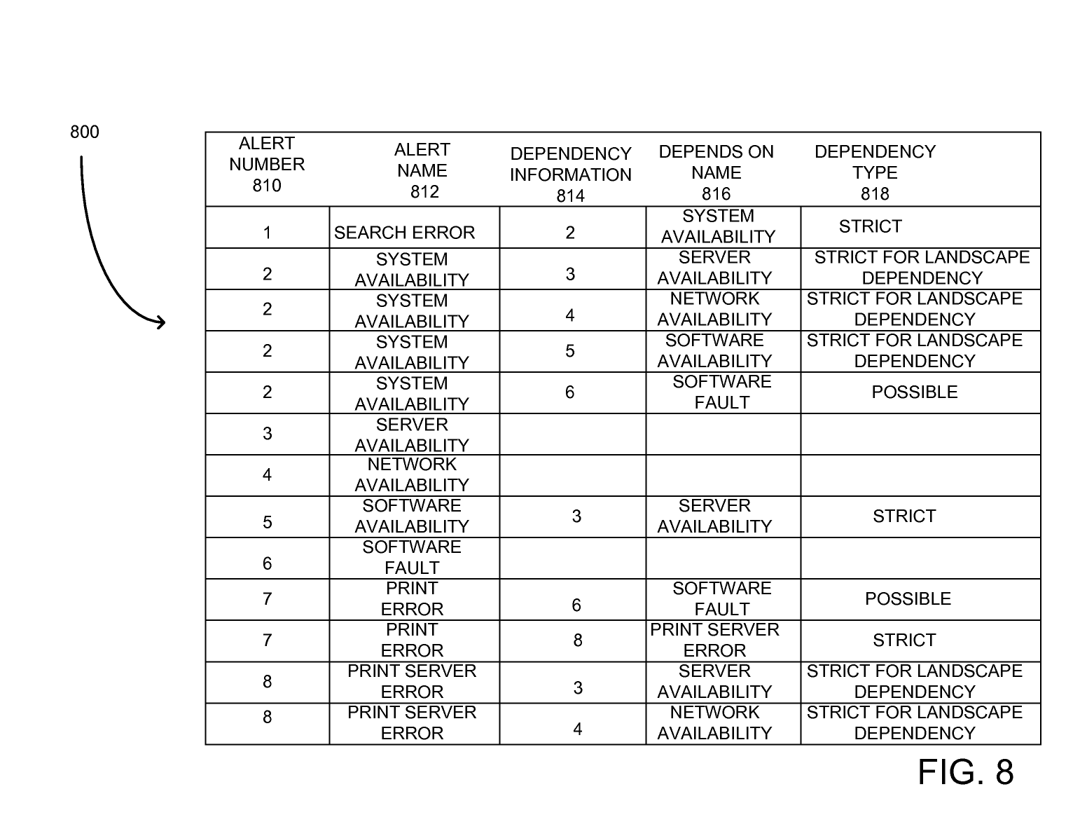

FIG. 8 is another example dependency matrix 800. The dependency matrix 800 can be any desired format depending on the particular system. The example dependency matrix 800 includes multiple columns including an “alert number” column 810, an “alert name” column 812, a “dependency information” column 814, a “depends on name” column 816, and a “dependency type” 818. The alert number 810 corresponds to a received alert. The alert name 812 is a name that describes the alert number 810. The dependency information 814 indicates how the alerts are associated together. For example, alert number 1 has dependency information associated with alert 2, as shown by the first entry in the dependency information column 814. The “depends on name” 816 provides the alert name from column 812. The dependency type 818 provides instructions on how to respond to the alert. For example, alert 1 has a “strict” dependency type. This means an alert is caused every time. Alert 2 has a dependency type of “strict for landscape dependency”. This means that the alert is caused only if the alert occurs in a predetermined landscape component. Other dependency types can include “possible” that indicates an alert may occur, but not in all cases. Thus, a variety of dependencies types can be associated with the alerts to provide further flexibility in how the alerts are handled.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). As should be readily understood, the term computer-readable storage media does not include communication connections, such as modulated data signals. Any of the computer-executable instructions for implementing the disclosed techniques as well as any data created and used during implementation of the disclosed embodiments can be stored on one or more computer-readable media (e.g., non-transitory computer-readable media, which excludes propagated signals). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

Having illustrated and described the principles of the illustrated embodiments, the embodiments can be modified in various arrangements while remaining faithful to the concepts described above. In view of the many possible embodiments to which the principles of the illustrated embodiments may be applied, it should be recognized that the illustrated embodiments are only examples and should not be taken as limiting the scope of the disclosure. We claim all that comes within the scope of the appended claims.

We claim:

1. A method of detecting alerts in a network landscape including multiple server computers coupled through a network, comprising:
receiving a first alert of a potential problem from a first application or first resource running in the network;
checking a dependency matrix to determine if a related alert has occurred that is associated with the first alert; and
if a related alert has already occurred, suppressing the first alert;
otherwise, transmitting the first alert for further evaluation.

2. The system of claim 1, further comprising checking whether the first alert is on a list of alerts that have an auto response, and if the first alert matches one of the alerts on the list, determining the auto response and transmitting the auto response to the first application or first resource without transmitting the first alert for further evaluation.

3. The method of claim 1, further including receiving multiple alerts associated with the first alert, automatically determining a root alert that caused the multiple alerts using the dependency matrix, aggregating the multiple alerts into the root alert and transmitting the root alert to a landscape controller to respond to the root alert.

4. The method of claim 1, further including using an update engine to automatically update the dependency matrix based on a rule set associated with the alerts.

5. The method of claim 1, further including storing the first alert with a time stamp so that subsequent alerts can check dependency on the first alert.

6. The method of claim 1, further including checking a time range of the related alert and suppressing the first alert if the time range is below a threshold.

7. The method of claim 1, wherein the network landscape includes a plurality of data centers receiving information from a common business process and the plurality of data centers are coupled to a common landscape controller that further evaluates the first alert.

8. The method of claim 1, wherein the first resource is a hardware component coupled to the network.

9. One or more computer-readable storage media storing computer-executable instructions for causing a computer to perform a method, the method comprising:
providing a hierarchy of system applications and resources that can transmit alerts to higher levels in the hierarchy for evaluating the alerts;
receiving multiple alerts from the system applications and/or resources in an alert aggregator;
automatically determining if the multiple alerts are associated with a same root problem;
transmitting a root alert from the alert aggregator to a help desk for evaluation.

10. The computer-readable storage media of claim 9, wherein determining if the multiple alerts are associated with the same root problem includes searching for a first alert of the multiple alerts in a dependency matrix and determining if others of the multiple alerts are associated with the first alert.

11. The computer-readable storage media of claim 9, further including suppressing the multiple alerts other than the root alert.

12. The computer-readable storage media of claim 10, wherein the dependency matrix includes a plurality of searchable alerts and, for each alert, a plurality of related alerts.

13. The computer-readable storage media of claim 12, further including determining if the alert has an associated auto response, and, if so, transmitting an auto response and suppressing passing the alert to the help desk.

14. The computer-readable storage media of claim 9, wherein the alerts have a severity threshold associated therewith, and an alert is transmitted to a higher level in the hierarchy if the severity threshold is exceeded.

15. The computer-readable storage media of claim 9, wherein the alert aggregator receives alerts from multiple levels in the hierarchy.

16. A system for detecting alerts in a network landscape environment, comprising:
a dependency matrix including a plurality of potential alerts and associated dependent alerts;
a query engine for searching the dependency matrix using a received alert as a key to the dependency matrix; and
an update engine for updating the dependency matrix to create dependencies between alerts.

17. The system of claim 16, wherein the query engine is part of an alert aggregator that receives results from the dependency matrix and that combines alerts into a root alert for transmission to a help desk.

18. The system of claim 16, wherein the network landscape environment includes a plurality of server computers running a common business application, a plurality of data centers in different countries associated with the common business application, and a landscape controller coupled to the data centers.

19. The system of claim 16, further including monitoring hardware to detect potential or actual problems in network resources and generating alerts associated therewith.

20. The system of claim 17, wherein the network landscape environment includes a hierarchy of agents that check the dependency matrix and pass alerts up the hierarchy if the alerts exceed a severity threshold.
